(19) United States
(12) Patent Application Publication
(10) Pub. No.: US 2011/0320234 A1
(43) Pub. Date: Dec. 29, 2011

(54) System, Method, and Computer Readable Medium for Management of an Electronic Calendar

(75) Inventor: David C. Mussman, Omaha, NE (US)

(73) Assignee: Open Invention Network, LLC, Durham, NC (US)

(21) Appl. No.: 12/822,259

(22) Filed: Jun. 24, 2010

(51) Int. Cl. G06Q 10/00; G06F 17/30

(52) U.S. Cl. 705/7.19; 707/769; 707/E17.014

(57) ABSTRACT

A system, method, and computer readable medium for providing management of electronic calendar appointments are provided. A database stores records of scheduled appointments of one or more users. The scheduled appointments may be displayed in a calendar view that includes scheduled appointments of the one or more users. A user may designate scheduled appointments associated with the user as private. The calendar system may then hide the scheduled appointments designated as private such that the private appointments are not displayed for view by other users. In another embodiment, a user may select multiple days for printing of scheduled events. In still another embodiment, a user may specify an interval for searching for a period of consecutive days during which the user does not have any scheduled appointments.

### FIELD OF THE INVENTION

The present invention is generally related to electronic calendars.

### BACKGROUND OF THE INVENTION

The near ubiquitous nature of computer systems and computer network environments has resulted in increased reliance on software applications that may provide enhanced efficiency of users' daily tasks in both work and personal life. One type of application that has emerged is referred to as an electronic calendar. The Microsoft Office Outlook™ Calendar is one example of a popular electronic calendar for managing personal information, appointments, meetings, and the like.

An electronic calendar may utilize a database for storage and access of one or more user's appointments. Electronic calendars deployed in a network environment may facilitate multi-user access and appointment management, and multiple users may share the same database for task management. Multiple users may access a common calendar database and the access and display of calendar data may become unwieldy. Further, no contemporary calendaring systems provide any mechanism for easily identifying non-scheduled periods of a particular duration that a user may desire, e.g., for vacation or other scheduling.

Therefore, what is needed is a mechanism that overcomes the described problems and limitations.

### SUMMARY OF THE INVENTION

The present invention provides a system, method, and computer readable medium for providing management of electronic calendar appointments. A database stores records of scheduled appointments of one or more users. The scheduled appointments may be displayed in a calendar view that includes scheduled appointments of the one or more users. A user may designate scheduled appointments associated with the user as private. The calendar system may then hide the scheduled appointments designated as private such that the private appointments are not displayed for view by other users. In another embodiment, a user may select multiple days for printing of scheduled events. In still another embodiment, a user may specify an interval for searching for a period of consecutive days during which the user does not have any scheduled appointments.

In one embodiment of the disclosure, a method for managing electronic calendar appointments is provided. The method includes receiving an identifier of a user, receiving a search period start date, receiving a search period end date, receiving a duration of consecutive days desired to be identified for which the user does not have any scheduled appointments, and searching a period specified by the start date and the end date for any periods of the duration during which the user does not have any scheduled appointments.

In another embodiment of the disclosure, a computer-readable medium having computer-executable instructions for execution by a processing system, the computer-executable instructions for managing electronic calendar appointments, is provided. The computer-readable medium includes instructions for receiving an identifier of a user, receiving a search period start date, receiving a search period end date, receiving a duration of consecutive days desired to be identified for which the user does not have any scheduled appointments, searching a period specified by the start date and the end date for any periods of the duration, and determining if a non-scheduled period of consecutive days equaling or exceeding the duration exists.

In a further embodiment of the disclosure, a system for maintaining scheduled events of one or more users in a database is provided. The system includes a storage device communicatively coupled with a server system for maintaining scheduled events of one or more users in a database, a client system for receiving a query, and a network that couples the client system with the server system. The query includes an identifier of a user, a search period start date, a search period end date, and a duration of consecutive days desired to be identified for which the user does not have any scheduled appointments. The database is searched for any periods of the duration between the start date and the end date.

### BRIEF DESCRIPTION OF THE DRAWINGS

Aspects of the present disclosure are best understood from the following detailed description when read with the accompanying figures, in which:

FIG. 1 depicts a simplified diagrammatic representation of a network system of data processing systems in which an electronic calendar system of the present invention may be implemented;

FIG. 2 is a block diagram of a data processing system that may be implemented as a server in accordance with an embodiment of the present invention;

FIG. 3 is a diagrammatic representation of a data processing system that may be implemented as a client system in accordance with an embodiment;

FIG. 4 is a diagrammatic representation of a database that may maintain calendar events in accordance with an embodiment;

FIG. 5 is a diagrammatic representation of a software configuration of a server system that may be implemented for facilitating multi-user access to an electronic calendar system implemented in accordance with an embodiment;

FIG. 6 is a diagrammatic representation of a relational database management system that may be run by a server for provisioning of an electronic calendar implemented in accordance with disclosed embodiments;

FIG. 7A is a diagrammatic representation of a calendar view that may be displayed by a client system in accordance with an embodiment;

FIG. 7B is a diagrammatic representation of a calendar view that may be displayed in response to selection of a particular user in accordance with an embodiment;

FIG. 7C is a diagrammatic representation of a week view of a calendar in accordance with an embodiment;

FIG. 8 is a diagrammatic representation of a graphical user interface that facilitates identification of non-scheduled periods in accordance with an embodiment;

FIG. 9 is a flowchart that depicts a non-scheduled period search routine implemented in accordance with an embodiment;

FIG. 10 is a flowchart that depicts a non-scheduled period search subroutine implemented in accordance with an embodiment; and

FIG. 11 is a flowchart that depicts a multi-user schedule search subroutine implemented in accordance with an embodiment.

### DETAILED DESCRIPTION OF THE INVENTION

It is to be understood that the following disclosure provides many different embodiments or examples for implementing different features of various embodiments. Specific examples of components and arrangements are described below to simplify the present disclosure. These are, of course, merely examples and are not intended to be limiting.

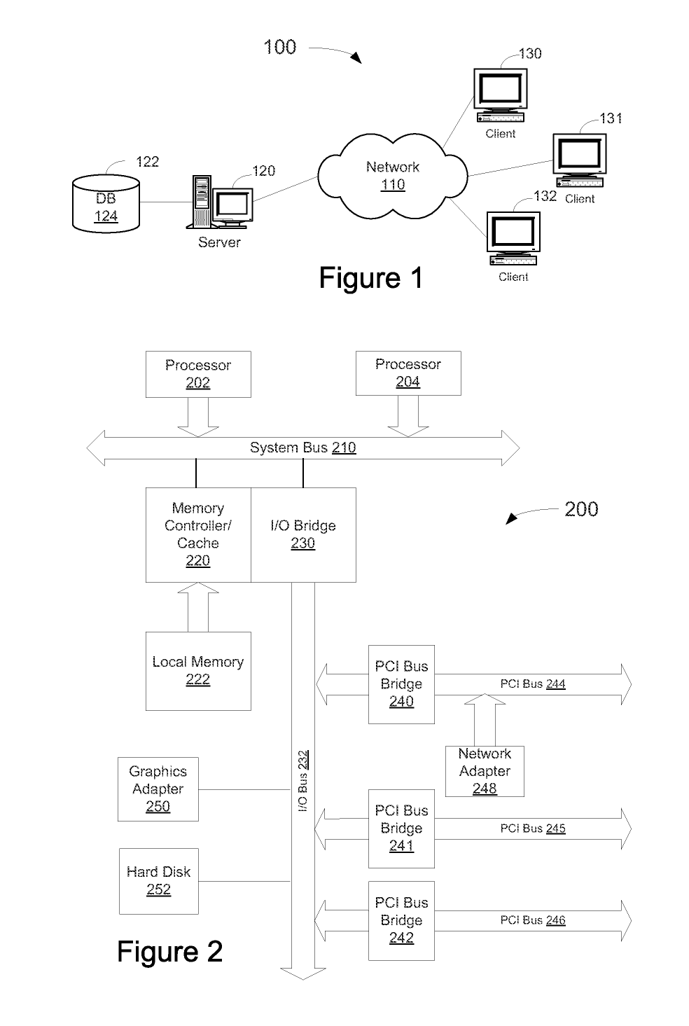

With reference now to the figures, FIG. 1 depicts a simplified diagrammatic representation of a network system 100 of data processing systems in which an electronic calendar system of the present invention may be implemented. System 100 comprises a network 110 that interconnects various computers or other data processing systems. To this end, system 100 includes a network 110, which provides a medium used for provisioning communication links between various devices and computers connected together within system 100. Network 110 may include any variety of connections, such as wire, wireless communication links, fiber optic cables, or any other suitable communication interfaces.

In the depicted example, system 100 includes a server 120 connected with network 110 along with a storage unit 122, such as one or more hard drives or other suitable storage devices. In an embodiment, storage unit 122 maintains a database 124 that maintains electronic calendar data as described more fully hereinbelow. To this end, server 120 may run a database management system (DBMS) that manages the database 124 and facilitates interaction therewith. In addition, system 100 may include various clients, such as clients 130-132 that are connected to network 110. Clients 130-132 may be, for example, personal computers, laptop computers, or other suitable data processing systems. In particular implementations, clients 130-132 may be clients to server 120. System 100 may include any variety of additional servers, clients, and other devices, and those depicted are shown only to facilitate an understanding of disclosed embodiments. In one implementation, network 110 may comprise the Internet and thus may represent a worldwide collection of networks and gateways that use the Transmission Control Protocol/Internet Protocol (TCP/IP) suite of protocols for network communications. Network 110 may also be implemented as a number of different types of networks, such as for example, an intranet, a local area network (LAN), a wide area network (WAN), or any variety of other network infrastructure. FIG. 1 is intended as an example, and not as an architectural limitation, of the present invention.

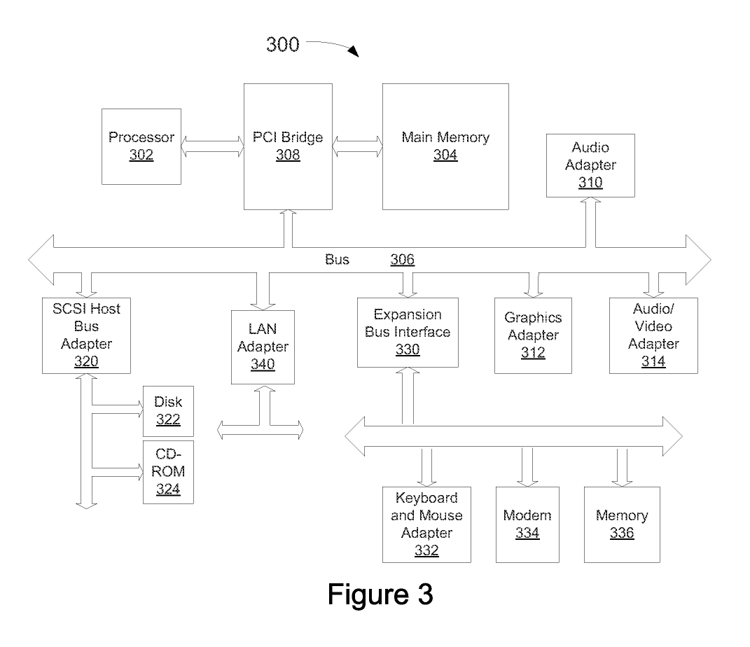

FIG. 2 is a block diagram of a data processing system 200 that may be implemented as a server, such as server 120 in FIG. 1, in accordance with an embodiment of the present invention. Data processing system 200 may be a symmetric multiprocessor (SMP) system including a plurality of processors 202 and 204 connected to system bus 210. Alternatively, a single processor system may be employed. Also connected to system bus 210 is memory controller/cache 220, which provides an interface to local memory 222. An I/O bus bridge 230 is connected to system bus 210 and provides an interface to I/O bus 232. Memory controller/cache 220 and I/O bus bridge 230 may be integrated as depicted.

A peripheral component interconnect (PCI) bus bridge 240 may be connected to I/O bus 232 and provides an interface to PCI local bus 244. Communications links to clients 130-132 in FIG. 1 may be provided through one or more network adapters 248 connected to PCI local bus 244 through add-in connectors.

Additional PCI bus bridges 241-242 provide interfaces for additional PCI local buses 245-246, from which additional network adapters or other peripherals may be supported. In this manner, data processing system 200 allows connections to multiple network computers. A memory-mapped graphics adapter 250 and hard disk 252 may also be connected to I/O bus 232 as depicted, either directly or indirectly. Storage unit 122 depicted in FIG. 1 may be network-connected with system 200 and thereby accessible through network adapter 248. Alternatively, storage unit 122 may be interconnected with system 200, e.g., via I/O bus 232.

Those of ordinary skill in the art will appreciate that the hardware depicted in FIG. 2 may vary. For example, other peripheral devices, such as optical disk drives and the like, also may be used in addition to or in place of the hardware depicted, and any variety of server architectures may be substituted for the depicted implementation. The depicted example is not meant to imply architectural limitations with respect to the present invention.

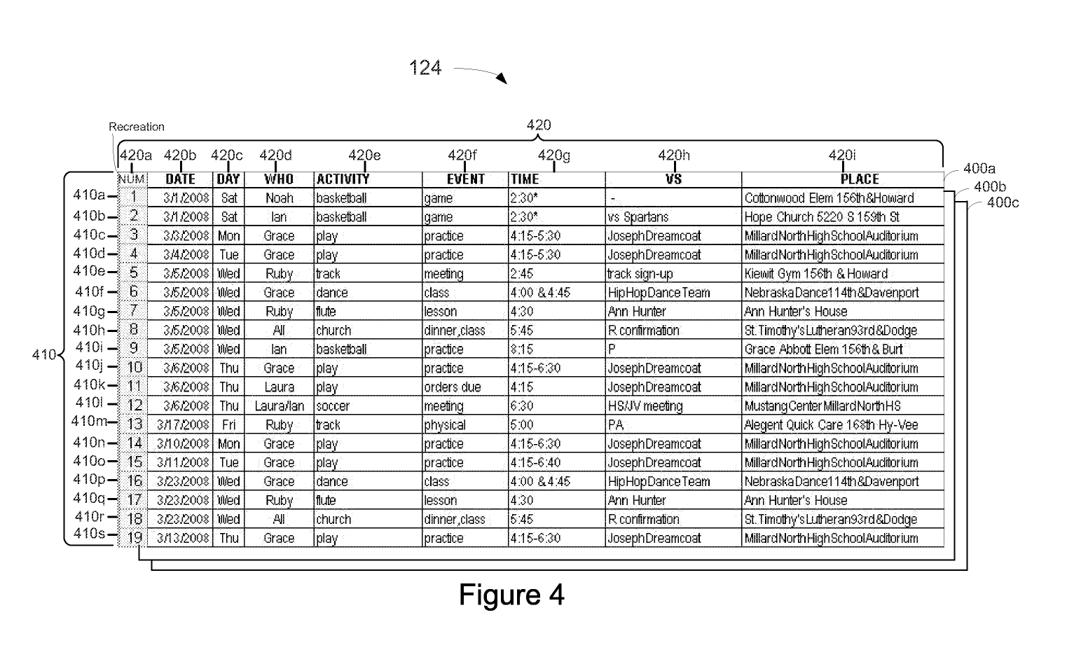

FIG. 3 is a diagrammatic representation of a data processing system 300 that may be implemented as a client system, such as client 130 depicted in FIG. 1, in accordance with an embodiment. In the illustrative example, data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. A processor 302 and a main memory 304 are connected to a PCI local bus 306 through a PCI bridge 308. PCI bridge 308 also may include an integrated memory controller and cache memory for processor 302. Additional connections to PCI local bus 306 may be made through direct component interconnection or through add-in boards. In the depicted example, a local area network (LAN) adapter 340, a SCSI host bus adapter 320, and an expansion bus interface 330 are connected to PCI local bus 306 by direct component connection. In contrast, an audio adapter 310, a graphics adapter 312, and an audio/video adapter 314 are connected to PCI local bus 306 by add-in boards inserted into expansion slots. Expansion bus interface 330 provides a connection for a keyboard and mouse adapter 332, a modem 334, and additional memory 336. A small computer system interface (SCSI) host bus adapter 320 provides a connection for a hard disk drive 322 and a CD-ROM drive 324. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. Instructions for the operating system, the object-oriented programming system, and applications or programs are located on storage devices, such as hard disk drive 322, and may be loaded into main memory 304 for execution by processor 302.

Those of ordinary skill in the art will appreciate that the hardware in FIG. 3 may vary depending on the implementation, and any variety of personal computer architecture or other data processing system devices may be suitably substituted for those depicted and described. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

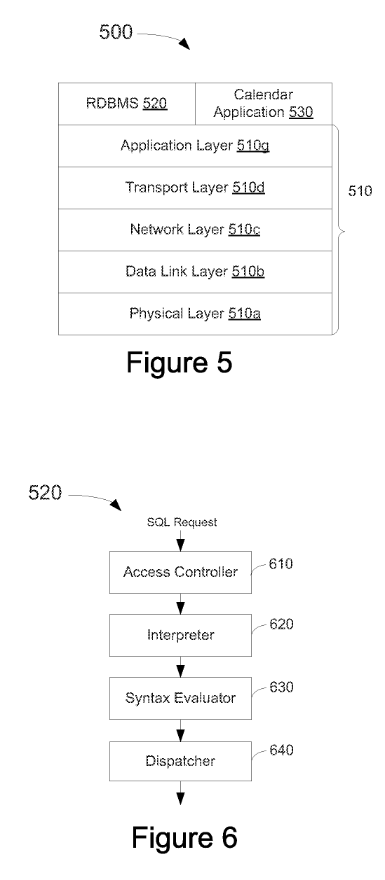

FIG. 4 is a diagrammatic representation of a database 124, or a portion thereof, that may maintain calendar events in accordance with an embodiment. The database 124 may be maintained on storage unit 122 that is included or interfaced with server 120 depicted in FIG. 1.

In the illustrative example, database 124 includes one or more tables 400a-400c. Table 400a comprises a plurality of records 410a-410s (collectively referred to as records 410) and fields 420a-420i (collectively referred to as fields 420) and may be stored on a disk drive or storage unit 122, fetched therefrom by server 120, and processed by a processor, such as processor 202 of data processing system 200 shown in FIG. 2. Each record 410a-410s, or row, comprises data elements in respective fields 420a-420i that individually specify a particular event attribute.

Table 400a may have a label, or identifier, assigned thereto. In the present example, table 400a has a label of “Recreation” and is used to store recreational scheduled events, e.g., athletic, extracurricular, or other recreational events. Fields 420a-420i have a respective label, or identifier, that facilitates insertion, deletion, querying, or other data operations or manipulations of table 400a. In the illustrative example, fields 420a-420i have respective labels of “Num,” “Date,” “Day,” “Who,” “Activity,” “Event,” “Time,” “VS,” and “Place.” Data elements of a particular field 420a-420i share a common data type, e.g., string, integer, float, etc. A particular field, e.g., field 420a, may be designated as a key field and each respective data element is unique within key field 420a. Assignment of unique values to data elements of key field 420a provides an identifier for records 410a-410s. Each of the records 410 specifies a scheduled event for a calendar user.

In the illustrative example, key field 420a has an identifier NUM and data elements of key field 420a comprise integers for uniquely identifying records 410a-410s. Field 420b has an identifier DATE and stores data that specifies a data including a month, day of the month, and year. In some database implementations, the DATE field 420b may store dates as strings, or even in some instances as integers. In still other implementations, the data of a DATE field may be stored as objects. Field 420c has an identifier DAY and stores string data that specifies a day of week corresponding to the date of field 420b. Field 420d has an identifier WHO and stores string data that specifies a person's name or identifier for whom the scheduled event of the corresponding record is recorded. Field 420e has an identifier ACTIVITY that stores string data that specifies an activity description of the scheduled event in a corresponding record. Field 420f has an identifier EVENT that stores sting data that specifies an event descriptor. Field 420g has an identifier TIME that stores data that specifies a schedule time of an event of a corresponding record. In some implementations, data of the TIME field may be stored as data of a datetime data type, while in other implementations data of the time field may be stored as string data. Field 420h has an identifier VS that stores string data that may specify an event opponent or other participant. Field 420i has an identifier of PLACE that stores sting data that specifies an event location. The depicted fields and content thereof are illustrative only and are provided only to facilitate an understanding of disclosed embodiments. Other tables, such as tables 400b-400c, may store any variety of scheduled events, such as work related events, educational events, or any other suitable events.

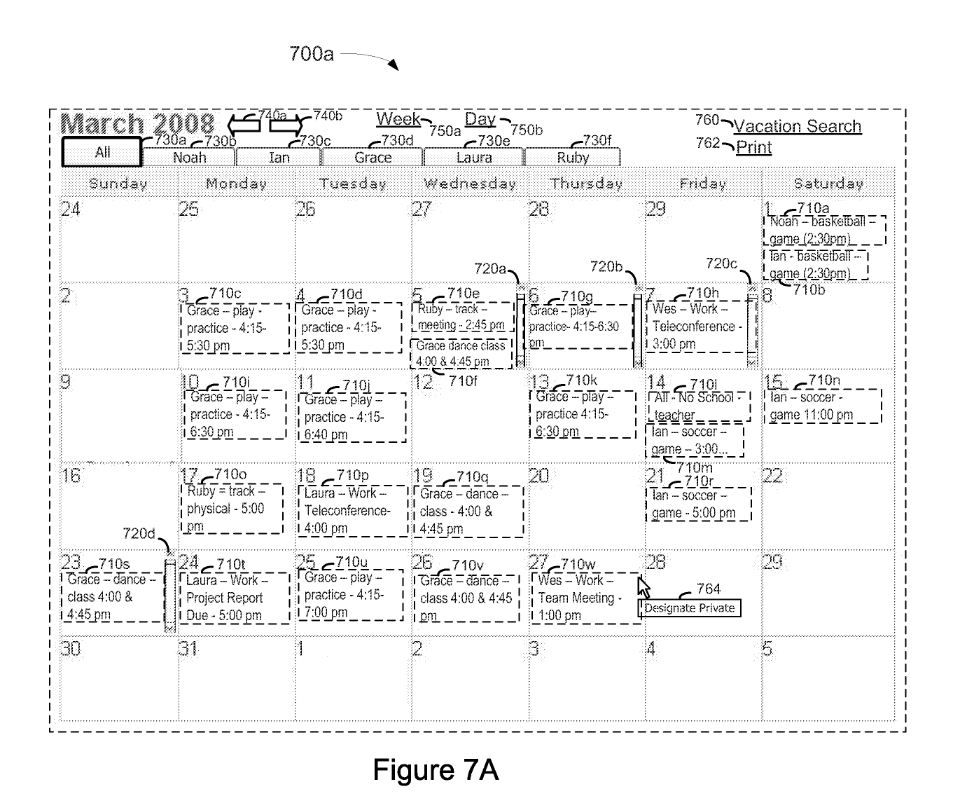

FIG. 5 is a diagrammatic representation of a software configuration 500 of a server system that may be implemented for facilitating multi-user access to an electronic calendar system implemented in accordance with an embodiment. In general, configuration 500 includes a network stack 510, also referred to as a protocol stack, comprising a collection of network software, e.g., implemented in the operating system, that provides access to a network, such as network 110. Network stack 510 may be implemented according to various configurations and capabilities and, in general, will include appropriate layers for accommodating external network interface(s) and various requisite network protocols. For example, network stack 510 generally includes a physical layer 510a, such as one or more of a 10/100 Base-T layer, a SONET layer, an 802.11 PHY layer, or any other suitable physical layer. The physical layer defines the electrical and physical specifications for the data processing system hosting the network stack, e.g., the physical specifications between the host data processing system and the physical medium. Network stack 510 may include a link layer 510b that provides functional and procedural mechanisms to transfer data between network entities and may provide for detection and correction of errors that may occur in the physical layer. Network layer 510b may comprise, for example, one or more of an Ethernet layer, an 802.11 media access control (MAC)/logical link control (LLC) layer, a point-to-point protocol layer, or the like. Network stack 510 may include a network layer 510c and a transport layer 510d. Network layer 510c provides functional and procedural mechanisms of transferring variable length data sequences while maintaining a quality of service. The Network layer also performs network routing functions, and may perform data fragmentation and reassembly functions among other services. Transport layer 510d provides transfer of data between end users and provides reliable data transfer services to upper layers. Further, the transport layer controls the reliability of a given link through flow control, segmentation/documentation, error control, may provide retransmission of data that has failed to be received by a recipient, as well as other services. In the continuing example, network 110 is implemented as the Internet, and calendar services hosted by server 120 may be accessed by clients 130-132 via network 110. To this end, network layer and transport layer may respectively include an Internet Protocol (IP) layer and a Transmission Control Protocol (TCP) layer. Other network and transport protocols may be likewise included within network and transport layers 510c-510d. An application layer 510e provides application services for various application processes. The application layer may include, for example, one or more of a File Transfer Protocol (FTP), a Simple Mail Transfer Protocol (SMTP), or any variety of higher level application layer protocol.

In an embodiment, a RDBMS 520 is included in software configuration 500 and provides for access and manipulation of database 124. Further, configuration 500 includes a calendar application 530 for provisioning of calendar services implemented in accordance with an embodiment as described more fully hereinbelow. Calendar application 530 may interact with RDBMS 520, e.g., for issuing queries, inserts, or other data manipulation of database 124.

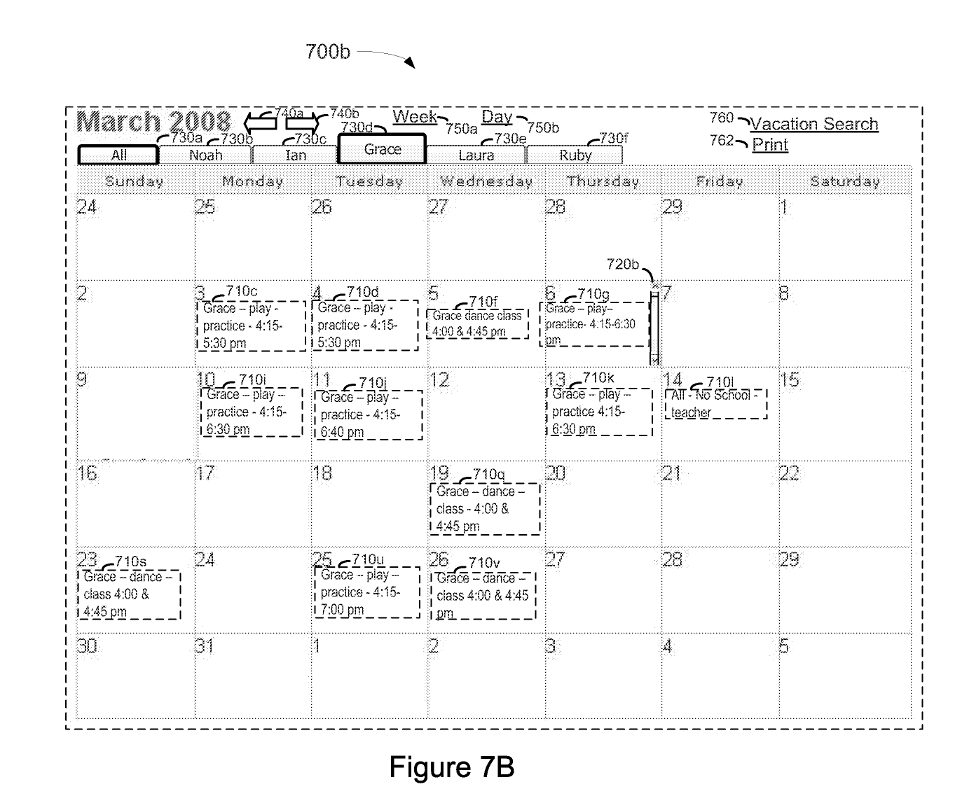

FIG. 6 is a diagrammatic representation of RDBMS 520 that may be run by server 120 for provisioning of an electronic calendar implemented in accordance with disclosed embodiments. The RDBMS may be implemented as various software modules implemented as computer-executable instructions executable by a processing system, such as the server 120 depicted in FIG. 1.

The RDBMS may include an access controller 610 that provides logon and logoff functions. Alternatively, access controller 610 may be implemented in calendar application 530. RDBSM 520 may include an interpreter 620 adapted to receive and interpret SQL requests and pass the requests to a syntax evaluator 630 which checks the request for proper syntax. Assuming the request comprises proper SQL syntax, the syntax evaluator 630 may pass the request to a dispatcher 640 which executes the request on the database 124. Various other RDBMS modules or components may be included, or substituted for any one or more, of those depicted, and the particular RDBMS configuration shown is for illustrative purposes only. For example, the RDBMS may include an optimizer that optimizes the execution plan

In accordance with an embodiment, an electronic calendar system that facilitates event scheduling among a group of users is provided. In a particular implementation, the electronic calendar system may be deployed in a client/server architecture such as that depicted in FIG. 1. For example, user's at clients 130-132 may access and interact with the calendar system via network access of server 120.

One or more users may have authorized access to a particular calendar maintained or interfaced by server 120. A user may access server 120 that, in turn, authorizes the user's access to the calendar system. In an embodiment, a particular calendar is defined by one or more event tables, such as tables 400a-400c, and one or more users may be registered for access to the particular calendar. Other tables, or sets of tables, may likewise be maintained or otherwise interfaced by server 120 and may have one or more other users registered for access to the calendar specified by those table(s). In the illustrative examples provided herein, a set of users designated “Person 1,” “Person 2,” “Person 3,” “Person 4,” and “Person 5” are assumed to be authorized users of the calendar specified by tables 400a-400c.

Authorized users may access the calendar system and receive the calendar for viewing on a client system, for example as a web page transmitted to the client system as hypertext markup language (HTML) viewable at the client via a browser or other suitable application. However, the calendar may be transmitted in any variety of code languages, either commercially available or proprietary. In some implementations, embedded code, such as JavaScript or another scripting language, may be transmitted by the server to a client to facilitate various functionalities implemented in accordance with embodiments. The embedded code may, for example, be transmitted in conjunction with HTML code that specifies the calendar, or a portion thereof.

In an embodiment, server 120, responsive to authorizing a user at a client station, transmits the calendar, or a portion thereof, in the form of, for example, data packets. In response to receipt of the data, a client system may display a calendar view, e.g., in a browser. The user may then view scheduled events in the calendar display, modify events, insert events, delete events, or perform various other actions as described more fully hereinbelow.

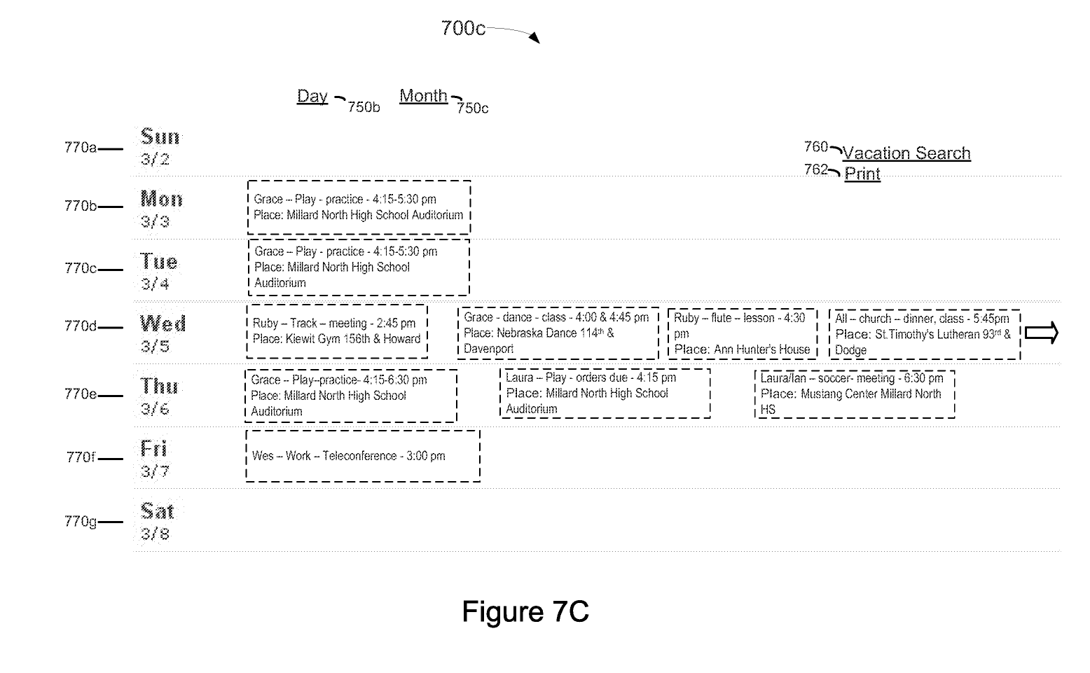

FIG. 7A is a diagrammatic representation of a calendar view 700a that may be displayed by a client system in accordance with an embodiment. In the illustrative example, calendar view 700a comprises a month view that includes respective panels for each day of the displayed month. Scheduled events to be displayed in a calendar view may be obtained by server 120, e.g., by executing an SQL SELECT query on tables 400a-400c with a date range predicate that defines, for example, the range of dates to be displayed. Scheduled events received by the server in response to execution of a query may be transmitted to a requesting client, e.g., as tagged HTML elements, that are displayed in calendar panels that correspond to the date of the scheduled events.

As shown in FIG. 7A, scheduled events as recorded in tables 400a-400c may be displayed in panels designated to correspond to the particular scheduled event date. For example, record 410a specifies an event for user “Person 1” scheduled at 2:30 on Mar. 1, 2008. The calendar view 700a includes a display object 710a that corresponds to the scheduled event defined by record 410a that is displayed within the date panel of “May 1” corresponding to the scheduled event date. The display object 710a preferably includes at least a portion of the scheduled event data of the corresponding record 410a. In a similar manner, display objects 710b-710w are displayed in respective date panels that corresponds to scheduled event dates of the event represented by the display objects 710b-710w. In some instances, more events may be scheduled than may be desirably displayed within a particular date panel in the calendar view 700a. In this instance, a control may be displayed in the panel that lets the user scroll through or otherwise display multiple display objects that are not viewable in a single date panel. For example, the date panel for “March 5” includes a scroll bar control 720a that, in response to user selection, e.g., by selection with a mouse cursor, provides for scrolling of display objects of scheduled events within the date panel. In a similar manner, scroll bar controls 720b-720d allow for scheduled event display object scrolling in corresponding date panels.

In some instances, a user may only be interested in viewing scheduled events related to the particular user. In other instances, a user may be interested in viewing only scheduled events related to another user or, alternatively, to a combination of particular users. In accordance with an embodiment, calendar view 700a may include various controls that allow for user selection of users for which scheduled events are to be displayed. For example, calendar view 700a may include various user-selectable tabs 730a-730f. A selected tab may be graphically distinguished from other tabs, e.g., by highlighting a selected tab, enlarging a selected tab, or by another visual indication. In the illustrative example, a selected tab is enlarged to thereby provide a visual indication of the selected tab. For example, in the present example, the tab 730a (designated “All”) is displayed with a larger graphical display that other tabs 730b-730f. Each tab may have an indicator of a particular user, or group of users, and selection of a tab results in display of scheduled events associated with the user(s) assigned to the tab. In the present example, tab 730a is associated with all the users, and thus calendar view 700a provides display of scheduled events of all the users. Assume for illustrative purposes that a user selects the tab 730d (assigned to user “Person 3”). In this instance, only scheduled events associated with the user “Person 3” are displayed as depicted by the diagrammatic representation of a calendar view 700b implemented in accordance with an embodiment as shown in FIG. 7B. In some instances, scheduled events may be associated with multiple users, such as the event specified by record 410h. In this instance, the event is associated with all users and is accordingly displayed in the calendar view 700b of scheduled events associated with the user “Person 3.”

In another embodiment, display objects may be graphically distinguished to facilitate identification of scheduled events associated with a particular user. For example, the calendar application may provide a highlight palette menu that allows users to select a highlight color for which display objects of scheduled events associated with the user are to be highlighted. For example, the user “Person 3” may select, via a calendar application menu or other control, to highlight display objects of scheduled events associated with the user “Person 3” in, for example, the color yellow. In this instance, display objects in the calendar view 700a that are associated with scheduled events of the user “Person 3” may be displayed in yellow thereby providing the user a visually efficient manner of locating the user's scheduled events.

Various controls may be provided for changing the particular calendar view. For example, scroll controls 740a-740b may be selected, e.g., through a mouse click or other user interaction, that cycles the calendar view to a respective previous or subsequent month.

A week view control 750a may be selected to cycle the current view from a monthly view to a weekly view. For example, a user may select week view control 750a, e.g., via a mouse click or other suitable input, and a week calendar view may then be produced at the client display as depicted by the diagrammatic representation of calendar week view 700c of FIG. 7C. The week view 700c includes panels 770a-770g each corresponding to a particular day of the week in which display objects of scheduled events may be displayed. In some implementations, more detailed data of a scheduled event may be provided in a display object when the calendar is displayed in the week view as opposed to the month view.

In accordance with an embodiment, a print control 762 may be selected for printing a calendar view. In another embodiment, one or more calendar panels of particular day(s) may be selected, and scheduled events corresponding to the selected days may be printed by selecting the print control 762. In this manner, a user may select a particular set of days, such as a particular weekend, and print events scheduled on the selected days by selecting the print control 762.

In accordance with another embodiment, a user may designate scheduled events as private so that only the particular user may view the scheduled event. For example, the user may select a particular event, such as an event corresponding to event object 710w, with a mouse cursor, and supply a right click or other control that results in selection of a private option control 764. By selecting the private option control, the corresponding scheduled event may be displayed only to the user to which the scheduled event is associated.

In accordance with an embodiment, the calendar system provides mechanisms for identifying non-scheduled periods of a specified duration of a user. In this manner, a user may easily locate non-scheduled periods in a manner that, for example, allows the user to schedule a vacation. In another embodiment, the calendar system provides mechanisms for identifying over-lapping non-scheduled periods of a specific duration or more than one user as described more fully hereinbelow.

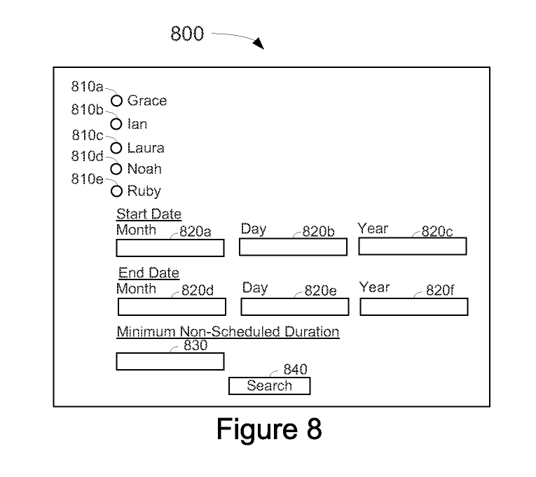

FIG. 8 is a diagrammatic representation of a graphical user interface 800 that facilitates identification of non-scheduled periods in accordance with an embodiment. The user interface 800 may be invoked, for example, upon selection of the vacation search control 760 depicted in FIGS. 7A-7C.

The user interface 800 may include various user-selectable controls 810a-810e each associated with a particular user. A user may select one or more controls 810a-810e to facilitate identification of periods for which the associated user(s) does not have any scheduled events. The user interface 800 may include fields 820a-820c for receiving user input of a start date of an interval to be searched for non-scheduled periods. Likewise, fields 820d-820f allow for input of an end date of the interval to be searched. A minimum non-scheduled duration may be supplied by the user in a field 830 that specifies the minimum number of consecutive non-scheduled days that is desired to be located. Upon supply of one or more users, a search period start date and end date, and a minimum non-scheduled period duration, the user may invoke the search, e.g., by selection of a control 840.

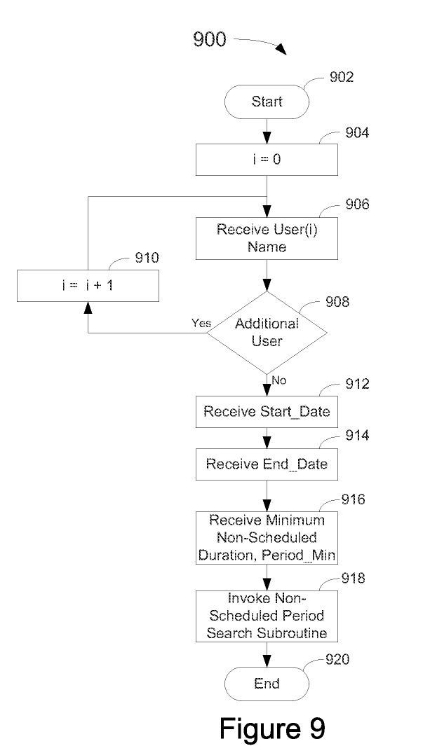

FIG. 9 is a flowchart 900 that depicts a non-scheduled period search routine implemented in accordance with an embodiment. The processing steps of FIG. 9 may be implemented as computer-executable instructions executable by a processing system, such as the server 120 depicted in FIG. 1.

The non-scheduled period search routine is invoked (step 902), and a user index, i, variable is initialized (step 904). The search routine then receives a user name, user(i), for which a specified interval of days is to be searched for the possible identification of one or more periods during which the user does not any events scheduled (step 906). The search routine then evaluates whether the schedule of an additional user is to be evaluated in conjunction with the user(i) (step 908). If the schedule of an additional user is to evaluated, the search routine may increment the user index, i, (step 910). The search routine may then proceed to receive the user(i) name. The names of users for which schedules are to be evaluated for non-scheduled periods may, for example, be stored by the search routine in a 1-by-i array.

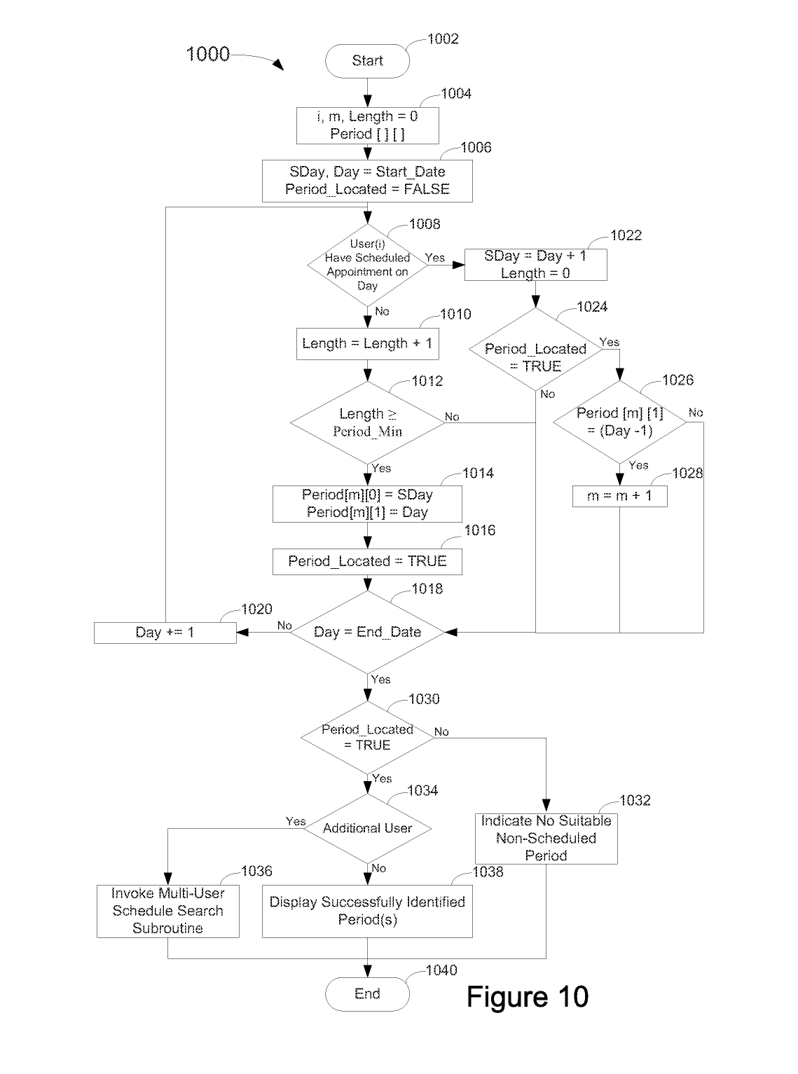

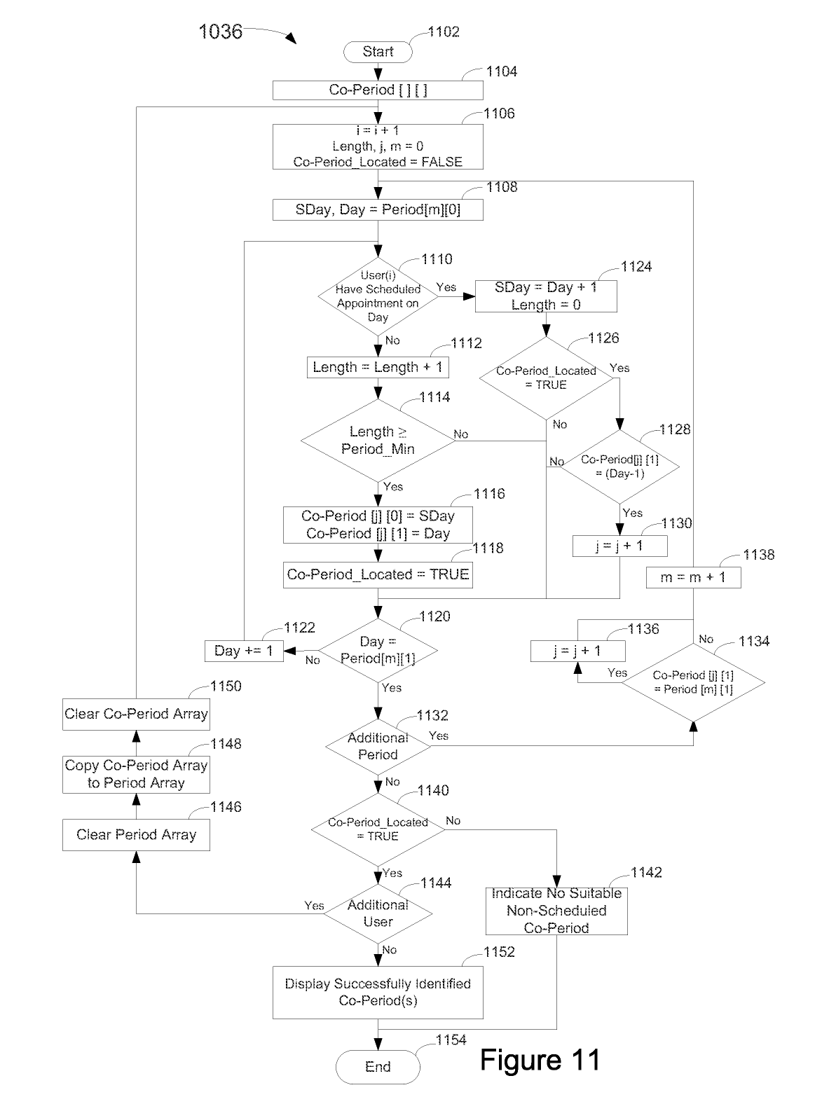

When all user names have been received by the search routine, the first date, Start_Date, of the interval to be searched for non-scheduled periods is received (step 912). For example, the Start_Date may be specified according to the search period start date specified by the user in fields 820a-820c of the user interface depicted in FIG. 8. Likewise, the last date, End_Date, of the interval to be searched for non-scheduled periods is received (step 914). A minimum non-scheduled period, Period_Min, may be received by the search routine (step 916), e.g., as specified by the user in field 830 of the user interface 800 depicted in FIG. 8, that specifies the minimum non-scheduled interval a user is interested in identifying. The search routine may then invoke a non-scheduled period search subroutine (step 918) that evaluates the specified search interval for non-scheduled periods for the one or more users as described more fully hereinbelow with reference to FIGS. 10 and 11. The search routine cycle may then end (step 920).

FIG. 10 is a flowchart 1000 that depicts a non-scheduled period search subroutine implemented in accordance with an embodiment. The processing steps of FIG. 10 generally correspond, at least in part, to the processing step 918 depicted and described with reference to FIG. 9. The processing steps of FIG. 10 may be implemented as computer-executable instructions executable by a processing system, such as the server 120 depicted in FIG. 1.

The search subroutine is invoked (step 1002), and various variables or other structures may be declared and/or initialized (step 1004). In the present example, the user index, i, is re-initialized to zero, and a period (or row) index, m, is initialized to zero. A length variable, Length, that is used to accumulate a count of consecutive non-scheduled days for a particular user is also initialized to zero. In an embodiment, period(s) that equal or exceed the minimum non-scheduled interval, Period_Min, may be stored in an array (designated Period). In a particular embodiment, the Period array may be specified as a double-subscripted, or two-dimensional, array in which each array “row” is used to store an identified period start date in the row's first element and the period end date in the corresponding row's second element. Accordingly, a double subscripted array, Period, may likewise be declared at step 1004. A variable, SDay, that is used to record the start day of a period having a duration that equals or exceeds the minimum non-scheduled interval is initialized to the start date of the search interval (step 1006). A variable, Day, that is used to record the last day of a period having a duration that equals or exceeds the minimum non-scheduled interval is likewise initialized to the start date of the search interval at step 1006. Further, a flag, illustratively designated as Period_Located, that is used to track whether a sufficient non-scheduled period has been located in the search interval may be initialized to FALSE at step 1006.

An evaluation is then made to determine if the user(i) has a scheduled appointment on the currently evaluated day, Day (step 1008). If the user(i) does not have any appointment scheduled on the currently evaluated day, Day, the Length variable is incremented (step 1010), and an evaluation is made to determine if the current non-scheduled period duration, as specified by Length, meets or exceeds the minimum period interval specified by the Period_Min variable (step 1012). If the current non-scheduled period length, Length, does not equal or exceed the minimum period length, the search subroutine may then proceed to determine whether the currently evaluated date, Day, comprises the last day (End_Date) of the search interval (step 1018).

Returning again to step 1012, if the current non-scheduled period length, Length, equals or exceeds the minimum period length, the search subroutine may then set the zeroth element of the current non-scheduled period, m, to the first day of the current non-scheduled period, that is SDay, and the first element of the current non-scheduled period, m, to the currently evaluated day, that is the date specified by the variable Day (step 1014). Thus, the Period array element Period[m][0] identifies the first day of a non-scheduled period that has been evaluated as equaling or exceeding the minimum non-scheduled period interval, and the Period array element Period[m][1] identifies the most recently evaluated last day of the non-scheduled period interval. The Period_Located flag may then be set to TRUE thereby indicating that a period of consecutive days that equals or exceeds the minimum period interval, Period_Min, has been identified for the user(i) (step 1016). The search subroutine may then determine whether the currently evaluated day is equal to the last day (specified by End_Date) of the interval to be searched for non-scheduled days (step 1018). If the current day, Day, is not equal to the last day of the search interval, the search routine processing may increment the current day, Day, being evaluated (step 1020) and thereafter return to step 1008 to evaluate whether the user(i) has a scheduled appoint on the currently evaluated day.

Returning again to step 1008, in the event that the user(i) has a scheduled appointment of the currently evaluated day, Day, the variable SDay used to track the first day of a non-scheduled period may be set to the increment of the currently evaluated day, Day (step 1022). That is, the SDay variable is set to the day subsequent to the current value of the Day variable. Further, the length variable, Length, may be re-set to zero at step 1022. The search routine may then evaluate whether any non-scheduled periods have been identified that equal or exceed the minimum non-scheduled interval, e.g., by evaluating the Period_Located flag (step 1024). If no non-scheduled periods equaling or exceeding the minimum period duration have been identified, the search subroutine may proceed to evaluate whether the currently evaluated day, Day, comprises the last day of the search interval according to step 1018. If a non-scheduled period equaling or exceeding the minimum non-scheduled period duration has been identified, the search routine may then evaluate whether the last day of the most recently identified non-scheduled period comprises the day (Day-1) preceding the currently evaluated day, Day (step 1026). If the last day (specified by Period[m][1]) of the most recently identified non-scheduled period is not the day preceding the currently evaluated day, the search subroutine may proceed to evaluate whether the currently evaluated day, Day, comprises the last day of the search interval according to step 1018. In the event that the last day (specified by Period[m][1]) of the most recently identified non-scheduled period is the day preceding the currently evaluated day, the search subroutine may increment the non-scheduled period, or row, index m (step 1028) and thereafter proceed to evaluate whether the currently evaluated day, Day, comprises the last day of the search interval according to step 1018.

When the currently evaluated day, Day, is determine to correspond to the last day, End_Date, of the search interval at step 1018, an evaluation may be made to determine if any non-scheduled period of consecutive days equal or exceeds the minimum non-scheduled period, e.g., by evaluating the Period_Located flag (step 1030). If the Period_Located flag does not indicate one or more non-scheduled consecutive day periods have been identified, e.g., if the Period_Located flag is not set to TRUE, the search routine may provide an indication, e.g., via a display output, that no suitable period of consecutive non-scheduled days is available (step 1032), and the search routine cycle may then end (step 1040).

Returning again to step 1030, if at least one period of consecutive non-scheduled days that equals or exceeds the minimum non-scheduled interval has been located, e.g., if the Period_Located flag is set to TRUE, the search routine may then determine whether the schedule of an additional user is to be evaluated in conjunction with the schedule of the user(i) that has been evaluated (step 1034). If an additional user remains for schedule evaluation, the search routine may invoke a multi-user schedule search subroutine (step 1036), and the search subroutine cycle may then end according to step 1040. In the event that no additional user remains for schedule evaluation, the search routine may then provide a notification, e.g., a visual output, of the period(s) of consecutive non-scheduled days of the user(i) (step 1038), and the search subroutine cycle may then end according to step 1040.

FIG. 11 is a flowchart 1036 that depicts a multi-user schedule search subroutine implemented in accordance with an embodiment. The processing steps of FIG. 11 generally correspond, at least in part, to the processing step 1036 depicted and described with reference to FIG. 10. The processing steps of FIG. 11 may be implemented as computer-executable instructions executable by a processing system, such as the server 120 depicted in FIG. 1.

The multi-user schedule search subroutine is invoked (step 1102). In an embodiment, co-period(s) that equal or exceed the minimum non-scheduled interval, Period_Min, and that fall within a non-scheduled period that equals or exceeds the minimum non-scheduled interval of consecutive days of a previously evaluated user may be stored in an array (designated Co-Period). In a particular embodiment, the Co-Period array may be specified as a double-subscripted array in which each array “row” is used to store an identified co-period start date in the row's first element and the co-period end date in the corresponding row's second element. To this end, a double subscripted array, Co-Period, may be declared (step 1104). Various variables or other structures may be declared and/or initialized (step 1106). In the present example, it is assumed that the user index, i, is passed to the multi-user schedule search. Accordingly, the user index, i, is incremented (step 1106). Additionally, the Length variable is re-initialized to zero. In the present example, the multi-user schedule search subroutine uses the length variable, Length, to accumulate a count of consecutive non-scheduled days of a co-period that falls within a period of consecutive non-scheduled days that has been identified for the user(0), i.e., the user for which the user's schedule has been evaluated according to the search subroutine described above with reference to FIG. 10. Further, a co-period index, j, is initialized to zero, and the period (or row) index, m, is re-initialized to zero at step 1106. A variable, SDay, that is used to record the start day of a co-period having a duration that equals or exceeds the minimum non-scheduled interval and that falls within a non-scheduled period of a previously evaluated user's schedule is initialized to the start date of the identified period (step 1108). That is, the variable SDay is initialized to the first day (Period[m][0]) of the first (zero^{th}) identified period of a previously evaluated user's schedule. Likewise, a variable, Day, that is used to record the last day of a co-period having a duration that equals or exceeds the minimum non-scheduled interval and that falls within a period of a previously evaluated user's schedule is likewise initialized to the first day of the previously identified period at step 1108. Further, a flag, illustratively designated as Co-Period_Located, that is used to track whether a non-scheduled co-period of a sufficient duration has been located in the search interval may be initialized to FALSE at step 1108.

An evaluation is then made to determine if the user(i) has a scheduled appointment on the currently evaluated day, Day (step 1110). If the user(i) does not have any appointment scheduled on the currently evaluated day, Day, the Length variable is incremented (step 1112), and an evaluation is made to determine if the current non-scheduled co-period duration, as specified by Length, meets or exceeds the minimum period interval specified by the Period_Min variable (step 1114). If the current non-scheduled co-period length, Length, does not equal or exceed the minimum period length, the search subroutine may then proceed to determine whether the currently evaluated date, Day, comprises the last day of the Period (Period[m][0] through Period[m][1]) identified for a previously evaluated user's schedule (step 1120).

Returning again to step 1114, if the current non-scheduled co-period length, Length, equals or exceeds the minimum period length, the search subroutine may then set the zeroth element of the current non-scheduled co-period, j, to the first day of the current non-scheduled co-period, that is SDay, and the first element of the current non-scheduled co-period, j, to the currently evaluated day, that is the date specified by the variable Day (step 1116). Thus, the Co-Period array element Co-Period[j][0] identifies the first day of a non-scheduled co-period that has been evaluated as equaling or exceeding the minimum non-scheduled period interval and that falls within a non-scheduled period of a schedule of a previously evaluated user, and the Co-Period array element Co-Period[j][1] identifies the most recently evaluated last day of the non-scheduled co-period interval. The Co-Period_Located flag may then be set to TRUE thereby indicating that a co-period of consecutive days that equals or exceeds the minimum period interval, Period_Min, has been identified for the user(i) (step 1118). The search subroutine may then determine whether the currently evaluated day is equal to the last day (specified Period[m][1]) of the interval to be searched for non-scheduled days according to step 1120. If the current day, Day, is not equal to the last day, Period[m][1], of the currently evaluated Period, the search subroutine processing may increment the current day, Day, being evaluated (step 1122) and thereafter return to step 1110 to evaluate whether the user(i) has a scheduled appointment on the currently evaluated day.

Returning again to step 1110, in the event that the user(i) has a scheduled appointment of the currently evaluated day, Day, the variable SDay used to track the first day of a non-scheduled co-period may be set to the increment of the currently evaluated day, Day (step 1124). That is, the SDay variable is set to the day subsequent to the current value of the Day variable. Further, the length variable, Length, may be re-initialized to zero. The search subroutine may then evaluate whether any non-scheduled co-periods have been identified that equal or exceed the minimum non-scheduled interval, e.g., by evaluating the Co-Period_Located flag (step 1126). If no non-scheduled co-periods have been identified, the search subroutine may proceed to evaluate whether the current day, Day, comprises the last day of the most recent Period(m) that has been searched for inclusion of any co-period(s) according to step 1120. If it is determined at step 1126 that a non-scheduled co-period has been identified, the search subroutine may then evaluate whether the last day of the most recently identified non-scheduled co-period comprises the day (Day-1) preceding the currently evaluated day, Day (step 1128). If it is determined at step 1128 that the last day (specified by Co-Period[j][1]) of the most recently identified non-scheduled co-period is not the day preceding the currently evaluated day, the search subroutine may proceed to evaluate whether the currently evaluated day, Day, comprises the last day of the Period(m) currently being evaluated for inclusion of any co-period(s) according to step 1120. In the event that the last day (specified by Co-Period[j][1]) of the most recently identified non-scheduled co-period is the day preceding the currently evaluated day, the search subroutine may increment the non-scheduled co-period, or row, index j (step 1130) and thereafter proceed to evaluate whether the currently evaluated day, Day, comprises the last day of the Period(m) currently being evaluated for inclusion of any co-periods according to step 1120.

When the currently evaluated day, Day, is determined to correspond to the last day, Period[m][1], of the current period, Period(m), being searched for any co-periods at step 1120, an evaluation may be made to determine if any additional non-scheduled periods have been identified for a previously evaluated user's schedule (step 1132). If an additional period remains to be evaluated for inclusion of any co-periods, an evaluation may be made to determine if the last day of the most recently identified co-period, if any, corresponds to the last day of the most recently evaluated Period(m) (step 1134). If the last day, Co-Period[j][1], of the most recently identified co-period corresponds to the last day of the most recently evaluated Period(m), the search subroutine may increment the co-period index, j, (step 1136), and proceed to increment the Period index (step 1138). If it is determined at step 1134 that the last day, Co-Period[j][1], of the most recently identified co-period does not correspond to the last day of the most recently evaluated Period(m), the search subroutine may proceed to increment the Period index, m, according to step 1138. It should be apparent that the search subroutine may determine that no co-period has yet to be identified at step 1134. In this instance, the search subroutine may proceed to increment the Period index, m, according to step 1134. After incrementing the Period index, the search subroutine may return to step 1108 to set the currently evaluated co-period(j) start day and end day to the first day of the current Period(m) to be evaluated for inclusion of one or more co-periods.

Returning again to step 1132, when no additional period remains for evaluation of the inclusion of any co-period, the search subroutine may evaluate whether any co-periods of consecutive days that equal or exceeds the minimum non-scheduled period duration have been identified, e.g., by evaluating the Co-Period_Located flag (step 1140). If the Co-Period_Located flag does not indicate that any non-scheduled co-periods have been identified that have a duration equaling or exceeding the minimum period interval, the search subroutine may provide an indication, e.g., via a display output, that no suitable co-periods of consecutive non-scheduled days are commonly shared among all the specified users (step 1142), and the search subroutine cycle may then end (step 1154).

Returning again to step 1140, if at least one co-period of consecutive non-scheduled days that equals or exceeds the minimum non-scheduled interval has been identified as commonly shared among the users' evaluated schedules, e.g., if the Co-Period_Located flag is set to TRUE, the search subroutine may then determine whether a schedule of an additional user remains to be evaluated (step 1144). If the schedule of an additional user remains to be evaluated, the search subroutine may clear the Period array (step 1146) and thereafter copy the Co-Period array to the Period array (step 1148). The Co-Period array may then be cleared (step 1150), and the search subroutine may then return to step 1106 to re-initialize the Length variable, the Co-Period index, j, and the Period index, m, as well as increment the user index, i, and reset the Co-Period_Located flag to FALSE. In this manner, the co-periods previously identified for the user(i-1) whose schedule was evaluated are now searched for the inclusion of co-periods in the schedule of the current user(i). In the event that no additional user remains for schedule evaluation, the search subroutine may then provide a notification, e.g., a visual output, of the identified Co-Period(s) commonly shared among the schedules of the users (user(0)-user(i)) (step 1152). The search subroutine cycle may then end according to step 1154.

As described, a system, method, and computer-readable medium for providing management of electronic calendar appointments are provided. A database stores records of scheduled appointments of one or more users. The scheduled appointments may be displayed in a calendar view that includes scheduled appointments of the one or more users. A user may designate scheduled appointments associated with the user as private. The calendar system may then hide the scheduled appointments designated as private such that the private appointments are not displayed for view by other users. In another embodiment, a user may select multiple days for printing of scheduled events. In still another embodiment, a user may specify an interval for searching for a period of consecutive days during which the user does not have any scheduled appointments.

The flowcharts of FIGS. 9-11 depict process serialization to facilitate an understanding of disclosed embodiments and are not necessarily indicative of the serialization of the operations being performed. In various embodiments, the processing steps described in FIGS. 9-11 may be performed in varying order, and one or more depicted steps may be performed in parallel with other steps. Additionally, execution of some processing steps of FIGS. 9-11 may be excluded without departing from embodiments disclosed herein.

The illustrative block diagrams depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single processor or multiple processors. Additionally, various steps of embodiments of the invention may provide one or more data structures generated, produced, received, or otherwise implemented on a computer-readable medium, such as a memory.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method of managing electronic calendar appointments, comprising:
receiving an identifier of a user;
receiving a search period start date;
receiving a search period end date;
receiving a duration of consecutive days desired to be identified for which the user does not have any scheduled appointments; and
searching a period specified by the start date and the end date for any periods of the duration during which the user does not have any scheduled appointments.

2. The method of claim 1, further comprising:
receiving a respective identifier of multiple users; and
identifying a period of consecutive days during which the users do not have any scheduled appointments.

3. The method of claim 2, wherein receiving an identifier further comprises receiving a plurality of identifiers each respectively associated with a one of a plurality of users, the method further comprising identifying a period of consecutive days during which the users do not have any scheduled appointments, wherein the period is included in the duration.

4. The method of claim 3, further comprising searching the period of consecutive days for a co-period of consecutive days during which a second user does not have any scheduled appointments.

5. The method of claim 1, further comprising:
identifying a period during which the user does not have any scheduled appointments; and
searching the period for any interval of consecutive days during which a second user does not have any scheduled appointments.

6. The method of claim 1, wherein receiving a duration further comprises receiving a duration from a user.

7. The method of claim 1, further comprising:
storing scheduled appointments each respectively associated with one of a plurality of users;
providing a display of the scheduled appointments;
receiving a selection of an identifier of one of the plurality of users; and
displaying scheduled appointments of the one selected user.

8. A computer-readable medium having computer-executable instructions for execution by a processing system, the computer-executable instructions for managing electronic calendar appointments, the computer-readable medium comprising instructions for:
receiving an identifier of a user;
receiving a search period start date;
receiving a search period end date;
receiving a duration of consecutive days desired to be identified for which the user does not have any scheduled appointments;
searching a period specified by the start date and the end date for any periods of the duration; and
determining if a non-scheduled period of consecutive days equaling or exceeding the duration exists.

9. The computer-readable medium of claim 8, further comprising instructions for:
receiving a respective identifier of multiple users; and
identifying a period of consecutive days during which the users do not have any scheduled appointments.

10. The computer-readable medium of claim 9, wherein the instructions for receiving an identifier further comprise instructions for receiving a plurality of identifiers each respectively associated with a one of a plurality of users, the computer-readable medium further comprising instructions for identifying a period of consecutive days during which the users do not have any scheduled appointments, wherein the period is included in the duration.

11. The computer-readable medium of claim 10, further comprising instructions for searching the period of consecutive days for a co-period of consecutive days during which a second user does not have any scheduled appointments.

12. The computer-readable medium of claim 8, further comprising instructions for:
identifying a period during which the user does not have any scheduled appointments; and
searching the period for any interval of consecutive days during which a second user does not have any scheduled appointments.

13. The computer-readable medium of claim 8, further comprising instructions for receiving a duration specifying a minimum duration of consecutive days, wherein the predefined duration is set to the received duration.

14. The computer-readable medium of claim 8, further comprising instructions for:
storing scheduled appointments each respectively associated with one of a plurality of users;
providing a display of the scheduled appointments;
receiving a selection of an identifier of one of the plurality of users; and
displaying scheduled appointments of the one selected user

15. A system for managing electronic calendar appointments, the system comprising:
a storage device communicatively coupled with a server system for maintaining scheduled events of one or more users in a database;
a client system for receiving a query; and
a network that couples the client system with the server system, wherein the query includes an identifier of a user, a search period start date, a search period end date, and a duration of consecutive days desired to be identified for which the user does not have any scheduled appointments, wherein the database is searched for any periods of the duration between the start date and the end date.

16. The system of claim 15, further comprising a display device communicatively coupled with the client system, wherein a period of the duration is identified and output on the display device.

17. The system of claim 15, wherein the database includes scheduled appointments of a plurality of users, and wherein a user may select a control specifying one or more of the plurality of users.

18. The system of claim 17, further comprising a display device, wherein scheduled appointments of one or more of the plurality of users are displayed in response to selection of the control.

19. The system of claim 15, wherein the storage device is communicatively coupled with a server system.

20. The system of claim 15, wherein the network comprises the Internet.
